(19) United States
(12) Patent Application Publication
(10) Pub. No.: US 2009/0292908 A1
(43) Pub. Date: Nov. 26, 2009

(54) Method and arrangements for multipath instruction processing

(75) Inventors: Karl Heinz Grabner, Pfeifersledlung (AU); Rumman Syed, Grosse Mohrengesse (AU)

Correspondence Address: Alan Carlson, 6202 Lynn Lane, Lago Vista, TX, 78645, US

(73) Assignee: On Demand Electronics

(21) Appl. No.: 12/154,577

(22) Filed: May 23, 2008

(51) Int. Cl. G06F 9/30

(52) U.S. Cl. 712/229; 712/E09.016

(57) ABSTRACT

A system is disclosed that includes a fetch stage to retrieve an instruction to be utilized by processing units in a multi-path pipeline. The instruction can have selectors that can select functions to be performed by individual paths of the pipeline that can accept and utilize the same instruction. A first processing unit in a first path can execute a part of the retrieved instruction in response to the function selector, and a second processing unit can execute a part of the retrieved instruction in response to the function selector. Other embodiments are also disclosed.

### TECHNICAL FIELD

This disclosure relates to parallel processing and to methods and arrangements for multipath instruction processing in pipeline architectures.

### BACKGROUND

As is well known, many instructions provided to an electronic processing device, such as a microprocessor, require a number of steps to be carried out by the processor. For example, an instruction to carry out an arithmetic operation on a pair of numbers which are stored in a memory can require that the two numbers be obtained from the correct addresses in the memory, that the arithmetic operation be obtained from a memory location, that the two numbers be operated on according to the arithmetic operation, and that the result be written back into memory. Many of the steps must be carried out in sequence or in consecutive clock cycles of the processor. Thus, a significant number of clock cycles can be required to execute each instruction.

Some manufacturers utilize a pipeline processing configuration to increase data throughput. A pipeline can include a series of stages where each stage carries out different types of processes so that while data is being retrieved for one instruction an arithmetic process can be performed on another instruction. In this configuration, a series of instructions can be moved into the pipeline one by one, each clock cycle, thereby increasing the data throughput of the system, since instruction are loaded every clock cycle. In non-pipeline systems the system loads an instruction and takes multiple cycles to execute the instruction as the next instruction waits for the previous instruction to be completed.

A scalar pipeline is a pipeline into which a maximum of one instruction per cycle can be issued. If stalls in the pipeline can be eliminated, the ideal situation of one clock cycle per instruction (1 CPI) is achieved which provides very efficient processing. However, it is desirable to reduce the number of clock cycles per instruction still further (CPI<1). To do this, more than one instruction per cycle should be issued from the pipeline. Thus, the “pipeline” could be viewed as having multiple paths or sub-pipelines where each path can operate as part of a multi-path pipeline. Thus, a superscalar design can be considered as one into which multiple instructions can be executed each clock cycle. Ideally, an N-way superscalar processing device would allow the execution of N instructions per clock cycle.

A superscalar design can be optimized in many ways and particularly it can be optimized for different types of instructions. For example, load/store instructions may be directed to one type of pipeline, and arithmetic instructions may be directed another type of pipeline. In other embodiments, pipelines can be divided into, for example, integer or floating point type pipelines. Therefore, there can be a number of specialized sub-pipelines arranged in parallel in a device were each sub-pipeline can be a different type of pipeline.

An N-way superscalar processing devices can execute N instructions per clock cycle. Each of the N pipelines can process instructions independent of other pipelines or they can share a program counter. Such solution are typically called MIMD (multiple instruction multiple data) architectures if the pipelines operate on different data or MISD (multiple instruction single data) if the pipelines operate on the same data whereas each pipeline can form the core of a so-called processing unit. Processing units can be arranged in parallel and can form parallel computation architectures.

The execution of N instructions each clock cycle, can require very broad instruction words that have to be fetched, and processed each clock cycle. This occurs because the instruction word has to contain one instruction code for each processing unit in the parallel pipeline. Processing units that have N instructions can require large switching logics that select one instruction out of N instructions for the processing unit each clock cycle. This switching logic often creates a relatively large propagation delay for data moving through the stages. Generally, the greater the width of the instruction word the slower the system must be clocked. Accordingly multipath pipelines are less than perfect.

### SUMMARY

In one embodiment a system is disclosed that includes a fetch stage to retrieve an instruction to be utilized by processing units in a multi-path pipeline. The instruction can have selectors that can select functions to be performed by individual paths of the pipeline. A decode stage can decode the retrieved instruction. A first processing unit can execute a part of the retrieved instruction in response to the function selector, and a second processing unit can execute a part of the retrieved instruction in response to the function selector. Thus, the contents of the instruction can dictate what path or processing unit processes the instruction and what path the function utilizes.

The system can also include a first function selection module to select a first function to be executed by the first processing unit and a second function processing module to select a second function to be executed by the second processing unit. In some embodiments the same data is processed by the first and second processing unit. However different functions can be executed by the different processing units. Each processing unit can be a sixteen bit or a thirty two bit processing unit.

The system can also include a detector module to detect a condition in the retrieved instruction and can command the loading of instructions. In response to the affirmed condition the detector module's loading command can assist in processing a first case and in response to a negated condition the detector module's can assist in processing a second case. In some embodiments the system can include a feedback path to return a result from a post execution stage to the first and/or second processing unit. In some embodiments, the first processing unit can produce a first result and the second processing unit will produce a second result. Both the first result and the second result can be placed in memory locations with adjacent addresses in the register file absent a register assignment instruction.

In another embodiment a method is disclosed that can include loading an instruction into a multi-path pipeline where the instruction has selector instructions. The method can include performing a first function on at least a portion of the instruction by a first processing unit in a first path in response to the selector instructions and performing a second function on at least a portion of the instruction by a second processing unit in a second path in response to the selector instructions.

In some embodiments the method can include detecting a condition in the instruction and loading instructions to support both an affirmative result from executing the condition and a negative result from executing of the condition. In some embodiments a first instruction can be executed with first data and a second instruction can be executed with the first data and the results can be stored in memory locations. The results can be stored in locations that have adjacent or consecutive addresses. In other embodiments the method can include feeding back a control signal from a stage that is subsequent to the first processing unit and selecting a function based on the control signal.

In yet another embodiment a machine-accessible medium that contains instructions which, when executed by a machine, can cause said machine to perform operations. The operations can include loading an instruction into a multi-path pipeline where the instruction has at least two selector sub-instructions. The operations can also include performing a first function on at least a portion of the instruction by a first processing unit in a first path in response to the selector instructions. Operations can also include performing a second function on at least a portion of the instruction by a second processing unit in a second path in response to the selector instructions.

### BRIEF DESCRIPTION OF THE DRAWINGS

In the following the disclosure is explained in further detail with the use of preferred embodiments, which shall not limit the scope of the invention.

FIG. 1 is a block diagram of a pipeline architecture of a processor core having two paths;

FIG. 2 is a block diagram of a processor architecture having parallel processing units;

FIG. 3 is a block diagram of a processor core having a parallel processing architecture;

FIG. 4 is an instruction processing pipeline consisting of an instruction cache pipeline and an instruction processing pipeline which has two paths;

FIG. 5 is a block diagram of a structure and instruction code;

FIG. 6 is a block diagram of an execute stage and a memory and register transfer stage that has two parallel processing paths;

FIG. 7a to FIG. 7f show a block diagram of a pipeline having two parallel processing paths;

FIG. 8 shows another embodiment of a pipeline architecture that has two selectable, parallel processing paths and can support processing or 16 bit words of a 32 bit word;

FIG. 9 shows a block diagram of a communication flow from the split pipeline to the register file; and

FIG. 10 is a flow diagram of a method of operating a multipath pipeline.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In one embodiment, methods, apparatuses and arrangements for processing of instructions in a multi-processor unit multipath pipeline that can be executed in very long instruction words (VLIW)s are disclosed. The multipath pipeline can support processing of instructions in at least two paths and can comprise of at least two execute stages, two forwarding stages, two memory and register transfer stages, and two post sync stages.

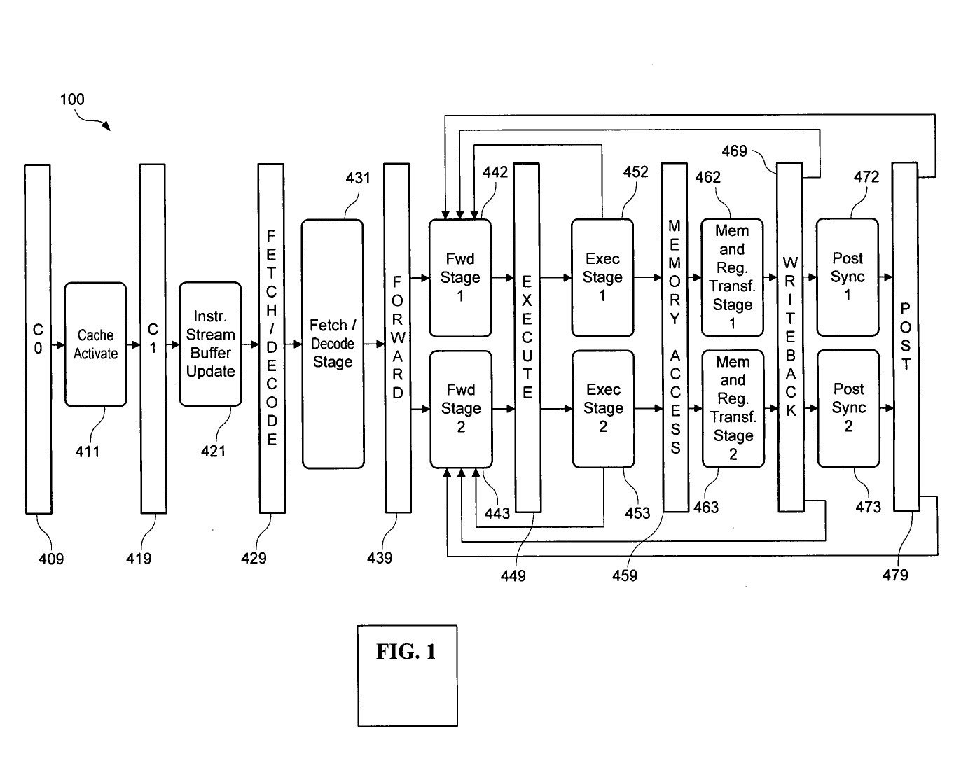

FIG. 1 is a block diagram of a multipath pipeline system 100 having multiple processing units. The system 100 have two pipelines, an instruction cache pipeline and an instruction processing pipeline, where the instruction cache pipeline can process the steps between the registers 409 and 429 and can be responsible to load internal instruction buffers from an instruction cache or an instruction memory. The system 100 can process the instructions between the registers 429 and 479 and can operate according to the loaded instructions. Each of the elements shown between two registers can represent a particular stage of the pipeline. The registers 409, 419, 429 439, 449 459, 469 and 479 are not essential to the operation of the pipeline and are provided to physically separate discrete elements for description purposes.

The fetch/decode stage 431 can fetch and/or decode instructions and can store the expanded instructions and data in the forward register 439. As shown in FIG. 1, the instructions can, in subsequent stages, be processed by at least one of two modules in each stage, referred to herein as split stages. Split stages can provide multiple paths of the multi-path pipeline. The split forward stages 442 and 443 can collect and hold data that can be used for processing in the execute stage. The split execute stages 452 and 453 can each execute instructions according to the program being loaded. The split memory and register transfer stages 462 and 463 can each store the results of the execution to internal registers (not shown) or to internal or external memories.

The split post-sync stages 472 and 473 can each hold data that is written to registers or to memories in the pipeline for subsequent forwarding to the execute stage. The system 100 can process instructions in a first path formed by the split stages 442, 452, 462, 472, and can process a same or different set of instructions in a second path formed by the split stages 443, 453, 463, 473. Thus, the system 100 can process the same instruction in parallel paths.

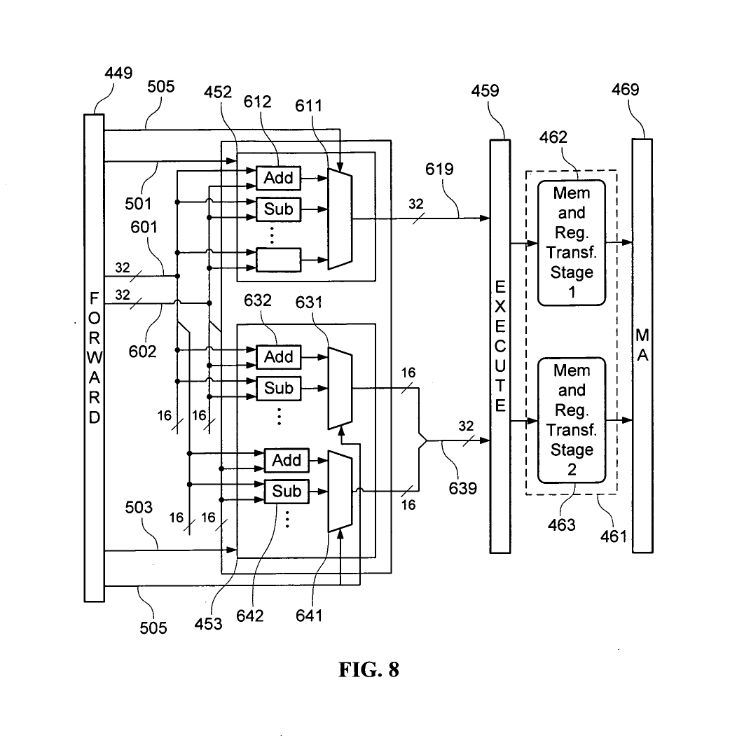

One of the features disclosed herein, is calculation logic and selection logic for each split stage. Such logic can be the same size and have the same complexity as is required by a single stage with the same functionality. The disclosed lower complexity selection logic provides less switching delay and faster switching times than traditional pipeline systems and hence, can be clocked at higher frequencies. Another feature disclosed is that data can be executed in different ways depending on the pipeline or pipelines that are selected to execute the given instruction. This feature can provide improved results if both pipelines have different specialties or characteristics. For example, the pipeline illustrated by elements 442, 452, 462 and 472 can be a 32 bit pipeline and the pipeline illustrated by elements 443, 453, 463 and 473 can be a 16 bit pipeline. Thus, a 32 bit wide pipeline can be provided with the 32 bit wide instructions. This embodiment is described in more detail in the description of FIG. 8.

Destination registers for instructions that use more than one parallel path can implicitly be provided with the instruction. An example of an instruction exploiting parallel paths of a processing unit having a split pipeline is “R3,R4=AS(R1,R2)” where A requests an ADD and S requests a SUBTRACT operation. The system 100 can concurrently calculate the sum and the difference of the values stored in the registers R1 and R2 by utilizing two parallel paths. The sum R1+R2 can be calculated in a first path and can be written to register R3 whereas the difference R1−R2 can be calculated in a second path and can be written to register R4.

In some embodiments, the destination register R4 can be automatically selected as a destination register that can store the calculation result of the second path (the difference) because R4 is adjacent to R3 and such a storage location doe not have to be coded in the instruction word. Hence, the instruction that stores the sum R1+R2 in R3 and the difference R1−R2 in R4 could be also written “R3=AS(R1,R2).” Accordingly, the target register R4 for the second path can be automatically derived from the specified target register R3 of the first path. This feature can save time and make instruction processing resources run more efficiently.

Embodiments for processing of instructions in split-pipelines, the split-pipeline selection mechanism and the execute stages of a split-pipeline are described in the following figures.

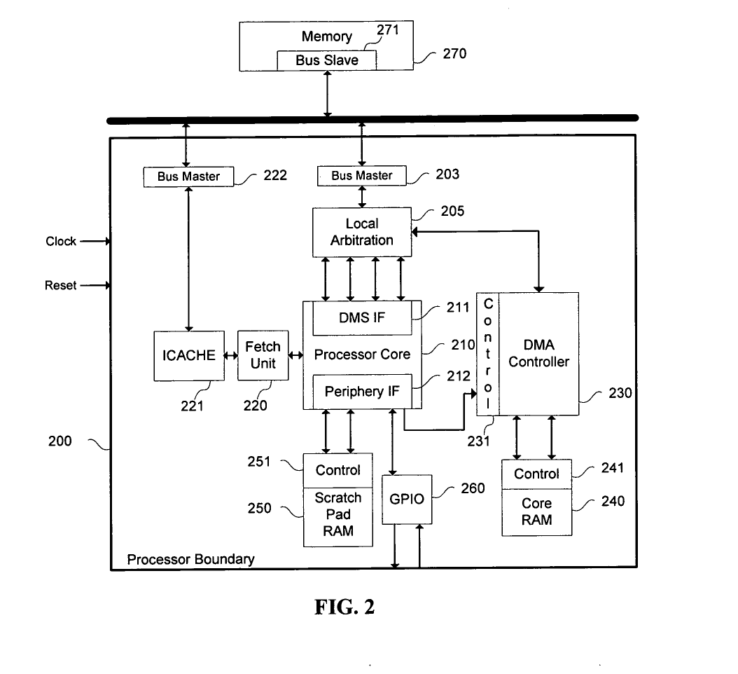

FIG. 2 is a block diagram of a single processor 200 embodiment which could be utilized to process image data, video data or perform signal processing, and control tasks. The processor 200 could be utilized in a multi-path, multiprocessor pipeline such as the one described in FIG. 1. The processor 200 can include a processor core 210 which can be responsible for computation and executing instructions loaded by a fetch unit 220 of the fetch stage. The fetch unit 220 can read instructions from a memory unit such as an instruction cache memory 221. The instruction cache memory 221 can acquire and cache instructions from an external memory 270 over a bus or interconnect network such that the instruction are quickly available to the fetch unit 220.

The external memory 270 can utilize bus interface modules 222 and 271 to facilitate instruction fetching or instruction retrieval. In some embodiments the processor core 210 can utilize four separate ports to read data from a local arbitration module 205. The local arbitration module 205 can schedule and access the external memory 270 using bus interface modules 203 and 271. In some embodiments, instructions and data are read over a bus or interconnect network from the same memory 270. However this is not a limiting feature, instead any bus/memory configuration could be utilized such as a “Harvard” architecture for data and instruction access.

The processor core 210 could also have a periphery bus which can be utilized to access and control a direct memory access (DMA) controller 230 via the control interface 231 and a fast scratch pad memory via a control interface 251. The processor core 210 can also communicate with external modules and a general purpose input/output (GPIO) interface 260. The DMA controller 230 can access the local arbitration module 205 and read and write data to and from the external memory 270. Moreover, the processor core 210 can access a fast Core RAM 240 to allow faster access to data. The scratch pad memory 250 can be a high speed memory that can be utilized to store intermediate results or data that is frequently utilized. The fetch and decode arrangements disclosed can be implemented by the processor core 210.

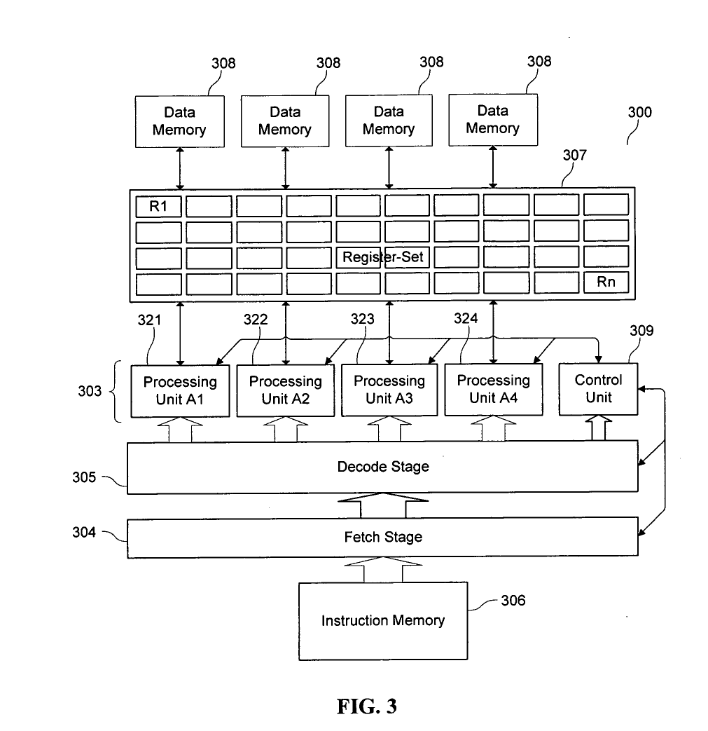

Referring to FIG. 3 a high-level block diagram of a processor system 300 that could be utilized as a multi-stage pipeline is disclosed. The processor 300 can implement the processor core 210 shown in FIG. 2. The processing pipeline of the processor core 300 can be facilitated by a fetch stage 304 that can retrieve data and instructions, and a decode stage 305 that can separate very long instruction words (VLIWs) into units processable by a plurality parallel processing units 321, 322, 323, and 324 in the execute stage 303. Furthermore, an instruction memory 306, can store instructions and the fetch stage 304 can load instructions into the decode stage 305 from the instruction memory 306. The processor core 300 illustrated contains four parallel processing units 321, 322, 323, and 324. However, the processor core 300 could have any number of parallel processing units which can be arranged in a similar way.

Data can be loaded from, or written to data memories 308 from a register area or register file 307. Generally, data memories can provide data for, and can save the results of the arithmetic results provided by the execute stage 303. The program flow to the parallel processing units 321-324 of the execute stage 303 can be influenced every clock cycle by control signals from control unit 309. The architecture shown illustrates connections between the control unit 309, processing units 321, 322, 323 and 324, and all of the stages 303, 304 and 305.

The control unit 309 can be implemented as a combinational logic circuit. The control unit 309 can receive instructions from the fetch 304 or the decode stage 305 (or any other stage) for the purpose of coupling processing units for specific types of instructions, related data or for specific types of instruction words. For example, the control unit 309 can selected between post conditional instructions based on a result of a conditional instruction. In addition, the control unit 309 can receive signals from a condition detector module or from an arbitrary number of individual or coupled condition detector modules. In one embodiment, parallel processing units 321-324, can act as a condition detector and can signal the control unit 309 if conditions are contained in the loaded instructions.

The parallel processing architecture has a fetch stage 304 which can load instructions and immediate values (data values which are passed along with the instructions within the instruction stream) from an instruction memory system 306 and can forward the instructions and immediate values to a decode stage 305. The decode stage can expand and split the instructions and pass the split instructions to the parallel processing units 321, 322, 323 and 324.

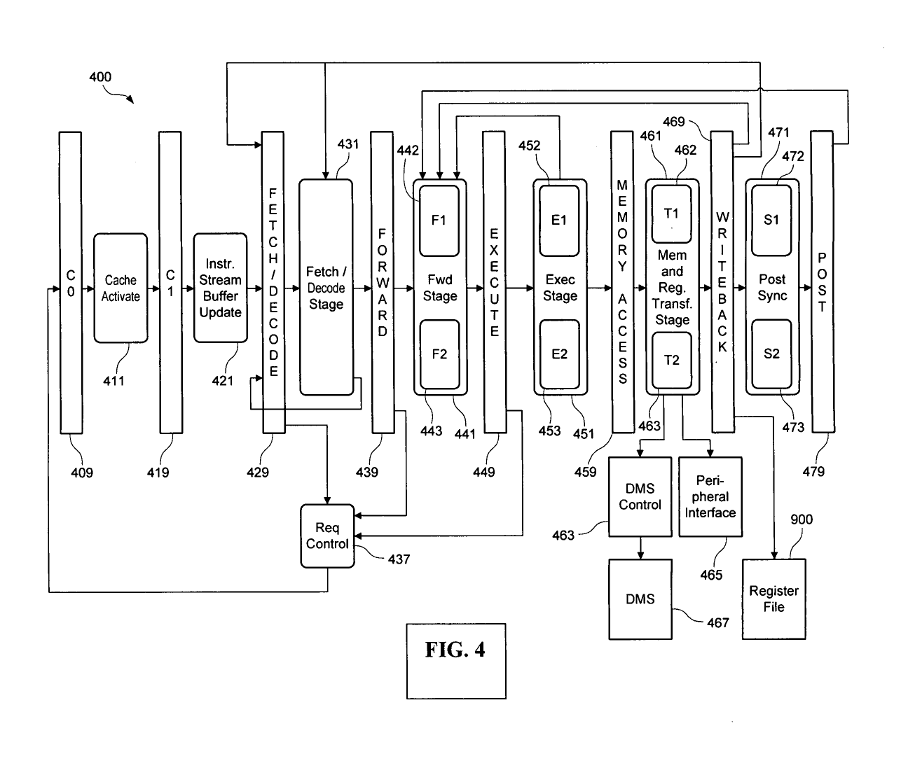

FIG. 4 depicts a pipeline that can be implemented in the processor core 210 of FIG. 2. However, the parallel stages which are depicted in FIG. 1 are omitted in FIG. 4 and only one path of the pipeline is shown for simplicity. The vertical bars 409, 419, 429, 439, 449, 459, 469, and 479 can denote pipeline registers. The modules 411, 421, 431, 441, 451, 461, and 471 can accept data from a previous pipeline register and may store a result in the next pipeline register. Modules and pipeline registers can form a pipeline stage. Other modules may send signals to no, one, or several pipeline stages which can be the same, a downstream, or an upstream pipeline stage.

The pipeline can consist of two coupled pipelines. One pipeline can be an instruction processing pipeline which can process the stages between the bars 429 and 479. An instruction cache pipeline can be coupled to the instruction processing pipeline and the instruction cache pipeline can process the steps between the bars 409 and 429.

The instruction processing pipeline can consist of several stages which can be a fetch-decode stage 431, a forward stage 441, an execute stage 451, a memory and register transfer stage 461, and a post-sync stage 471. The fetch-decode stage 431 can contain a fetch stage and a decode stage. The fetch-decode stage 431 can fetch instructions and instruction data, can decode the instructions, and can write the fetched instruction data and the decoded instructions to the forward register 439. Instruction data can be defined as a value which is included in the instruction stream and passed into the instruction pipeline along with the instruction stream. The forward stage 441 can prepare the input for the execute stage 451. The execute stage 451 can consist of a multitude of parallel processing units as explained above in FIG. 3. In some embodiments, the processing units can access the same register file as has been described with reference to FIG. 3. In other embodiments, each processing unit can access its own register file.

One type or instruction provided to a processing unit of the execute stage can be to load a register with instruction data provided as part of the instruction. However, the data can need several clock cycles to propagate from the execute stage which has executed the load instruction to the register. In a conventional pipeline design without the disclosed “forward functionality” the pipeline may have to stall until the data is loaded into the register such that the requested data in available in the register for the subsequent instruction. Some conventional pipeline designs do not stall in this case but disallow the programmer to query the same register for one or more cycles of the instruction sequence.

In some embodiments, a forward stage 441 can accept a data request and can load the requested data into registers in (a) subsequent clock cycle(s). The execute stage can then use the loaded data and instructions to produce a result. Accordingly, the data can move in a parallel with the instructions and the data can propagate through the pipeline and/or additional modules towards the registers.

In some embodiments, the memory and register transfer stage 461 can transfer data from memories to registers or from registers to memories. The memory and transfer stage 461 can also control access to one or even a multitude of memories which can be a core memory or an external memory. The stage 461 can communicate with external periphery through a peripheral interface 465 and can access external memories through a data memory sub-system (DMS) 467. The DMS control module 463 can be used to load data from a memory to a register whereas the memory is accessed by the DMS 467.

A pipeline can process a sequence of instructions each clock cycle. However, each instruction processed in a pipeline can take several clock cycles to pass all stages. Hence, it is possible for data to be loaded into a register in the same clock cycle as an instruction in the execute stage requests the data. In accordance with the present disclosure a post sync stage 471 can have a post sync register 479 to hold such data in the pipeline. It can be appreciate that the data can be transferred from the post sync register 479 to the execute stage 451 by the forward stage 441 very quickly. The forward stage 441 can inject the requested data into the stream just ahead of the execute stage 451. The method can include feeding back a control signal from a stage that is subsequent to the first unit and selecting a function with the control signal. The method can also include feeding back a control signal from a stage that is subsequent to the second processing unit and selecting a function with the control signal.

Some of the stages of the pipeline architecture shown in FIG. 4 are split to make multiple paths. Each path can include a sequence of split stages that can operate mutually exclusively or each path can operate in parallel. The pipeline can process instructions from a very long instruction word (VLIW). The execute stage 451 can include two paths with stages 452 and 453. Each of the split execute stages 452 and 453 can store their result in register 459 and the results can be forwarded to the memory and register transfer stage 461.

The memory and register transfer stage 461 can also include split stages 462 and 463 and can transfer data to registers or memories (not shown) and can forward data to writeback register 469. The post-sync stage 471 can also be a split into stages 472 and 473 which can receive the results of the prior split stage in the same path and can pass the contents of the post register 479 to the forward stage 441 if or when requested. The forward stage 441 can include two split forward stages 442 and 443. The split forward stages 442 and 443 can select the appropriate data from a number of inputs for the next instruction and can send the appropriate data to the appropriate path of the execute stage 452 or 453.

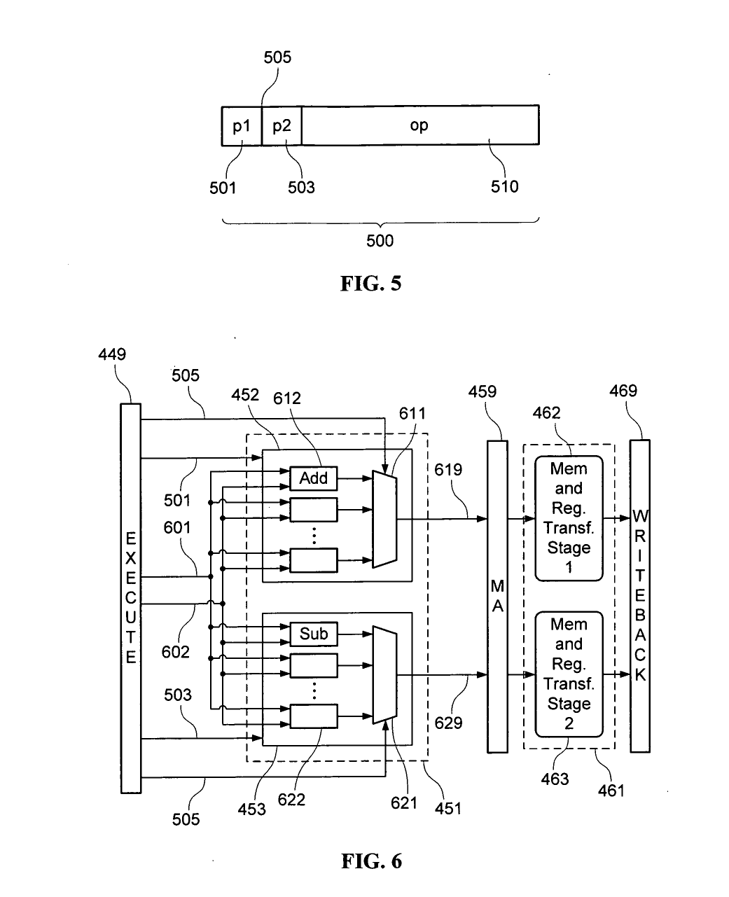

FIG. 5 shows a structure of instruction code 500 that can be processed in the pipelines 100 and/or 400 described above. The instruction code 500 can include selector bits 505 that can control how the instructions and data are processed in a multipath pipeline. The instruction code 500 can include an operational code 510 and selector bits 505. The operational code 510 can provide a function to be provided by a processing unit or a plurality of processing units in a split execute stage. Thus, the operational code 510 can dictate what function will be executed by at least one execute stage, and/or how data is processed by at least one processing unit. The selectors 505 can control which processing unit receives and executes the function contained in the operational code 500. The group of selectors 505 can include a selector bit for each path of the multi-path pipeline.

In some embodiments, the position or location of the selector bit (such as selector bits 501 and 503) in the code 500 can determine which of the paths in a pipeline process an instruction or which paths process which instruction. In the example of FIG. 5 and FIG. 1 the selector 501 (the first bit of the code) can control activity in the first path and the selector 503 (the second bit in the code) can control activity of the second path.

In some embodiments, each selector 503 can be single bit and thus can be either a “logical 1” or a “logical 0.” The existence of a logical 1 can assign a path or processing unit to execute the code 510 and the existence of a logical 0 can dictate that a path or processing unit is not assigned to the instruction. If both selectors are set to “1”, both paths can be assigned to execute the instruction and both paths can execute the code 510. It can be appreciated that the code 510 could also include separate instructions for each executes stage.

FIG. 6 shows an embodiment of the execute stage of FIG. 1 in more detail. The execute stage 451 can include the split execute stages 452 and 453 which can be arranged in parallel to each other. It can be appreciated that only two stages are shown for simplicity and the present disclosure supports employing many more parallel stages. The split execute stages 452 and 453 can each have a set of function modules 612 and 622 respectively.

The function modules 612 and 622 can provide specialized functions for operating on data. The specialized functions can include addition, multiplication, median, or mean to name a few. Such functions can be created or modified depending on the type of processing that the system performs and thus, the functions available to a system can be tailored to a particular processing application. The application specific functions can be instructions that are utilized frequently by a particular processing application. For example, a video processing application frequently has the need to find the median value for a set of values. Quickly finding the median can improve decompression techniques and can provide for more efficient rendering of video and pictures.

Each split execute stage (452 and 453) can receive a selector signal (501 and 503) from the execute register 449 or from another stage such as a prior stage and the execute stages 452 and 453 can execute instructions responsive to the selector signals 501 and 503. A selector signal and instruction format was described above with reference to FIG. 5. In some embodiments, the split execute stage 452 can receive a selector signal 501 and the split execute stage 453 can receive a selector signal 503. In some embodiments, a selector signal of “1” can activate a stage and a selector signal “0” can deactivate or disable a stage.

Each of the split execute stages 452 and 453 can also receive a series of values illustrated by the arrows 601 and 602 which can be data that can be operated on by the functions in the execute stage. Each split execute stage can also receive the operational code 510 and can utilize the code 510 to select a function to operate on the data via selection logic. The split execute stage 452 can, in some embodiments, use the code 510 to switch the selection logic 611, and or to select a function 612.

In addition, the split execute stage 453 can use the incoming code to switch the selection logic 621 such that a function 622 can be selected. As stated above the execute stages can operate mutually exclusive or in concert. It can be appreciated, that the code 510 can be the same for all execute stages, however, the functions that can be activated and can operate on the data can be different, i.e., the functions 612 can be completely different from the functions 622. Such control provides additional flexibility in a processing environment.

In other words, the data 601 and 602 can be applied to a set of functions 612 and 622 where each function can belong to a particular path of an execute stage (452 and 453). The function can be selected, activated or deactivated using switching logic 611 and 621 where the switching logic 611 and 621 can be controlled by selector signals 501 and 502 in the instructions or by other stages. Other stages may control the switching logic based on results of an execution of an instruction. In addition, each split execute stage can be controlled by a selector signals 501 and 503.

In some embodiments all switching logic can be controlled by operational code 510. Therefore, the combination of the operational code and the selectors can determine what functions that are executed on the data. Each split execute stage can forward its result and the selector signal to a next split stage in the same path of a next stage. The next stage in the embodiment shown in FIG. 6 can be the memory and register transfer stage 461.

Traditional pipeline processing approaches typically employ a single selection logic in the instruction to select a function from all available functions where the function can utilize the data to provide a result from a single function. Therefore, the selection logic in traditional systems must select one function from a plurality of functions and when the process is required to compute multiple functions the pipeline must be reloaded to process time it processes a single function.

The disclosed system can process multiple functions per pass. The multifunction per pass architecture disclosed is less complex and easier to implement than architectures that execute a single function on each path as performed by conventional approaches. In some embodiments many functions are selected from subsets of functions and this results in short logic switching delays and, hence, the disclosed system can be clocked at higher frequencies.

As illustrated, functions can be divided into groups (i.e. two groups 612 and 622), and each group can have small and efficient selection logic 611 and 612. As stated above, only two parallel split pipelines with two paths are depicted, however, a plurality of paths such as thirty two paths could operate in a similar manner and the two path embodiment should not be utilized to limit the scope of the disclosure. It can be appreciated that the disclosed configuration allows for higher clock speeds and the flexibility of parallel selectable paths of split pipelines.

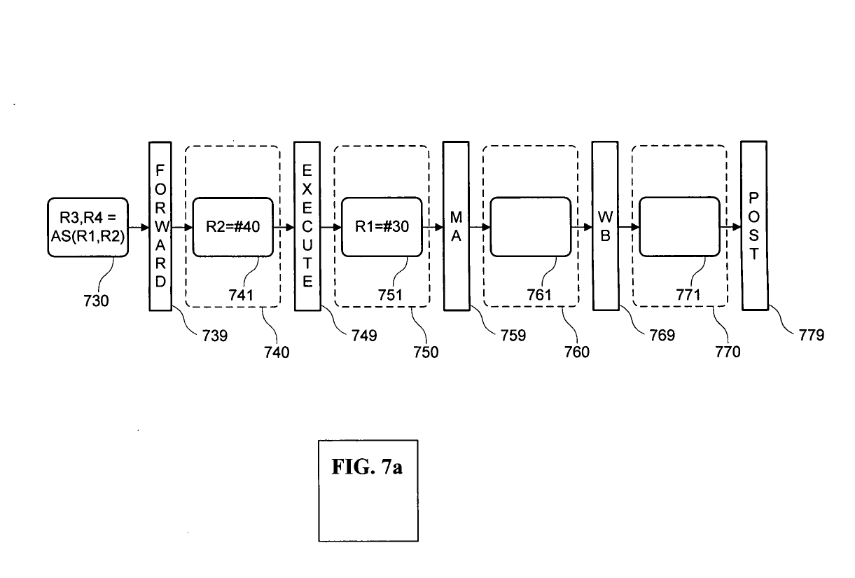

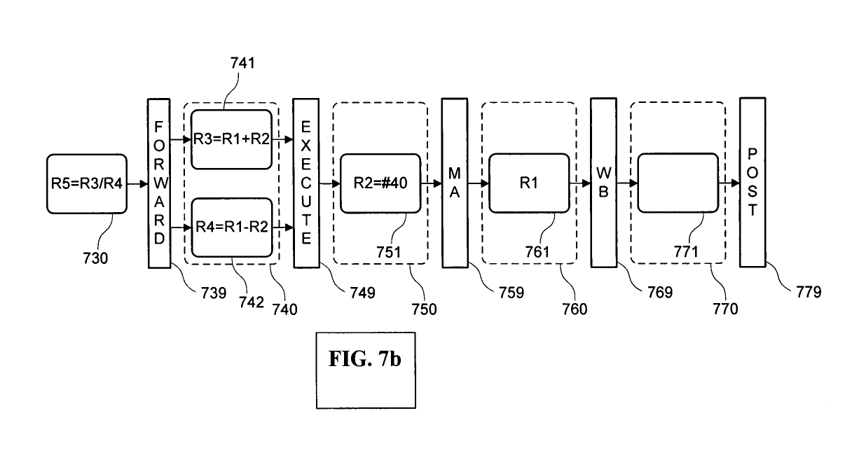

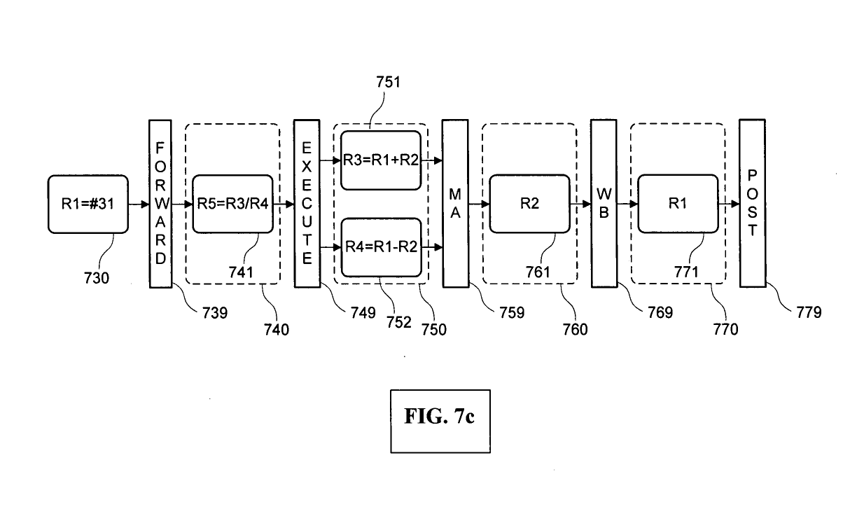

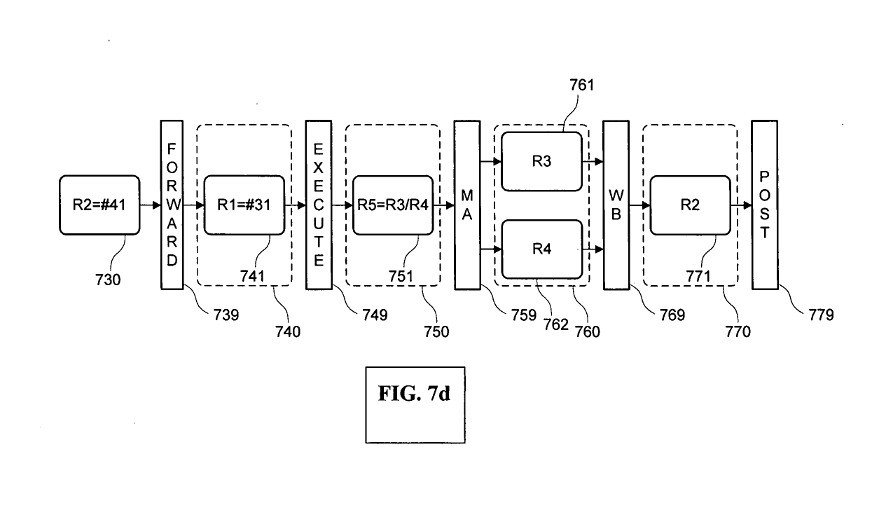

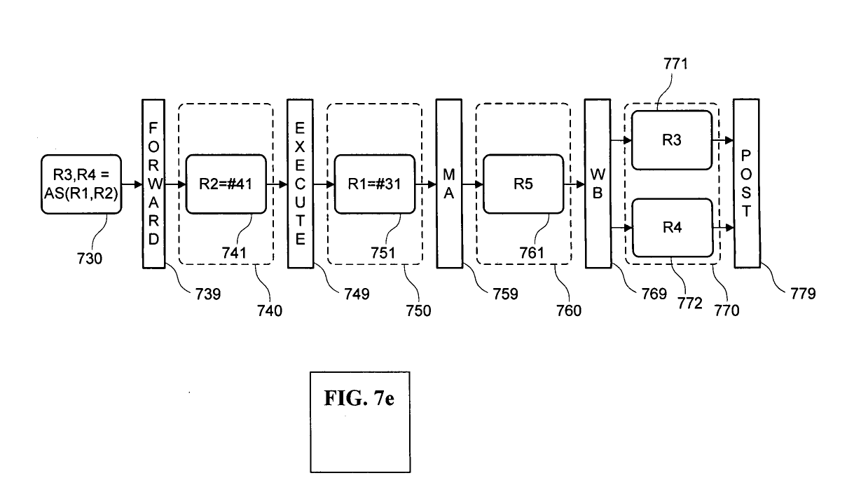

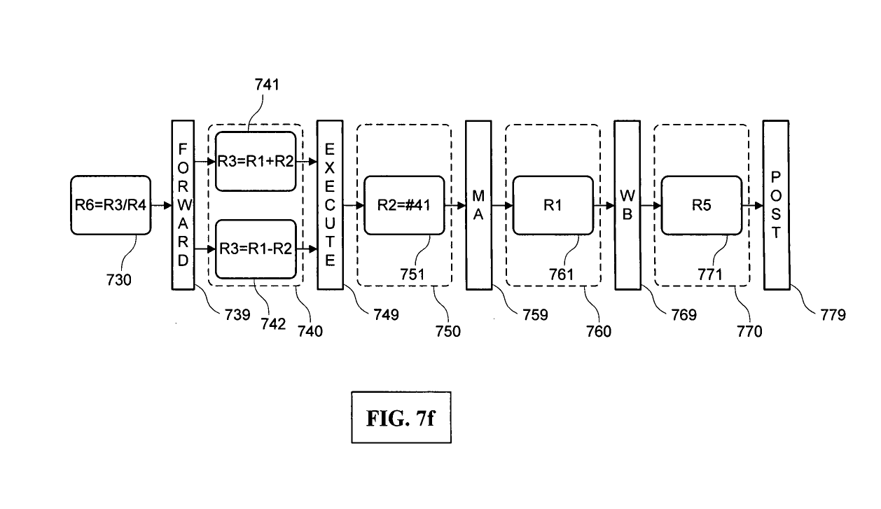

FIG. 7a to FIG. 7f are block diagrams depicting a pipeline processing system. The split stages have been simplified and are illustrated with instructions that are “in-process.” The boxes or stages which are empty illustrate stages which are not processing instructions. Boxes that contain only one register name (such as “R1”) indicate that values resulting from an execution of an instruction are to be stored in the denoted register. As illustrated, register names can start with an “R” followed by a number, e.g., “R1” can refer to register 1 and “R5” can refer to register 5.

Boxes 740, 750, 760, and 770 in FIG. 7a illustrate stages in the pipeline that can contain the split stages. Stages 741, 751, 761, and 771 (see FIGS. 7b, c, d, e respectively) illustrate a first path and of a split pipeline and stages 742, 752, 762, and 772 (see FIG. 7b, c, d, e respectively) illustrate a second path of a split pipeline.

In FIG. 7a the instruction “R1=#30” can be executed in the split execute stage 751. The instruction “RI=#30 can instruct the processor to load data from address 30 to register 1 while the instruction “R2=#40” is prepared in the split forward stage 741 and the instruction “R3,R4=AS(R1,R2)” can be decoded in a decode stage 730. All other split stages 761, and 771 may not process instructions and can be idle, which can be the case if “R1=#30” is the first instruction after a reset or the process has just begin. All of the instructions can be processed in the first path of FIG. 7a. The instruction “R3,R4=AS(R1,R2)” can be a function that can make use of processing in two parallel paths exploiting the multipath pipeline. In one embodiment, the function “AS” can mean “add-subtract” and such instructions can instructs the processor to calculate the sum and the difference of values of data (i.e., in the example of FIG. 7a to calculate the sum and the difference of the registers R1 and R2 and to store the results in the registers R3 and R4 respectively).

FIG. 7b represents the state of the pipeline one cycle later that what is illustrated in FIG. 7a. The memory operation “load register R1 with data from address 30” can be processed in split stage 761 in a first path, while the instruction “R2=#0” can be executed in split stage 751 in a first path, the instruction “R3,R4=AS(R1,R2)” can be broken up into two instructions “R3=R1+R2” and “R4=R1−R2” in the stage 740, and the instruction “R5=R3/R3” can be decoded in a decode stage 730. The instruction “R3=R1+R2” can be assigned to the split stage 741 in a first path and “R4=R1−R2” can be assigned to split stage 742 in a second path. However, as discussed in FIG. 5 the operational code or code to be executed can be the same for both the first and the second path. In the example of FIG. 7b all stages can use the first path except the split forward stages 741 and 742 for which both paths can be active or activated.

In FIG. 7c the data for register R1 can be transferred to register 779 by split stage 771 in a first path, while data for register R2 can be loaded from memory in split stage 761 in a first path. Both instructions “R3=R1+R2” and “R4=R1−R2” can be executed in split stages 751 and 752 in a first and a second path, the instruction “R5=R3/R4” can be prepared in split stage 741 in a first path, and the instruction “R1=#31” can be decoded in a decode stage 730. It is to note, that the operational code used in the split execute stages 751 and 752 can be the same for both the first and the second path however the paths can perform different functions because different stages can use different control signals in the code. In FIG. 7c all stages can operate only the first path except the execute stage 750 for which both the first and second path are active 751 and 752.

FIG. 7d can show the same pipeline one clock cycle after FIG. 7c. The data for register R2 can be transferred to register 779 by split stage 771 in a first path, while the instruction “R5=R3/R4” can be executed in split stage 751 in a first path. The instruction “R1=#31” can be prepared in a split forward stage 741 in a first path, and the instruction “R2=#41” can be decoded in stage 730. Data (the sum and the difference) can be transferred to registers R3 and R4 and be processed by the split stages 761 and 762 a first and a second path. In FIG. 7d all stages can operate in the first path except the split stages 761 and 762 for which both paths can be active.

In FIG. 7e the data for both registers R3 and R4 can be transferred to register 779 by the split stages 771 and 772 in a first and a second path, while data can be written to register 5 in a register file (not shown) of the processor. The instruction “R1=#31” can be executed in split stage 751 in a first path, the instruction “R2=#41” can be prepared in a split forward stage 741 in a first path, and the two-path instruction “R3,R4=AS(R1,R2)” can be decoded in stage 730. In FIG. 7e all stages can operate in the first path except the stage 770 for which both paths 771 and 772 can be activated.

In FIG. 7f the data for register R5 can be transferred to register 779 by the split stage 771 in a first path, while data can be written to register 1 in a register file (not shown) of the processor, the instruction “R2=#41” can be executed in split stage 751 in a first path, the parallel pipelined instructions “R3=R1+R2” and “R4=R−R2” can be prepared in the split forward stages 741 and 742 in a first and a second path, and the instruction “R6=R3/R4” can be decoded in stage 730. In FIG. 7f all stages can operate in the first path except the stage 740 for which both paths through the split stages 741 and 742 can be activate.

The progression of an instruction from FIG. 7a to FIG. 7f shows the execution of instructions in a multi-path pipeline that utilizes part of the instruction to activate additional parallel paths. Accordingly, each stage can operate in a one-path or multi-path mode depending on the instructions to be processed. Selectors, as part of the instruction can determine which paths in which stage should be activated for processing. Results of the instruction processing in a stage can be forwarded to a next stage which can, in the next cycle process the instructions according to the selectors associated to the instructions in a one-path or multi-path mode.

FIG. 8 provides another embodiment of an execute stage such as an execute stage that could be utilized in FIG. 1. The split execute stage 452 can also be similar to that of FIG. 6. The logical execute stage can include first path execute stage 452 and a second path execute stage 453 which can be arranged and operate in parallel to each other. Each execute stage 452 and 453 can receive a selector signal (501 or 503) from the execute register 449 or a prior or subsequent stage and can be execute an instruction in response to this signal. Thus the split execute stage 452 can receive the selector signal 501 and the split execute stage 453 can receive the selector signal 503 generally from any stage. Each of the split execute stage 451 and 452 can receive also a series of values or data as illustrated by the arrows 601 and 602. Each split execute stage 452 and 453 can also receive the operational code 510 or selectors that can select a function to be executed using selection logics 611, 631, and 641.

In FIG. 8 the split execute stage 453 can have two sets of 16-bit functions 632 and 642. The split execute stage 453 can use the selector bits in the operational code 510 to select one function in each of the two sets of 16-bit functions 632 and 642. In some embodiments selecting can be performed using the selection logic 631 and 641. However, code can dictate the selection of a function 612 assigned to the switching logic 611, and a function 632 assigned to switching logic 631, and a function 642 assigned to the switching logic 641. As the functions can be different, the same code can select different functions in different paths such that different functions are executed on the data in different paths.

Functions 632 can perform a 16-bit operation on the lower 16 bits of the data 601 and 602 and functions 642 can perform a 16-bit operation on the higher 16 bits of the data 601 and 602 while the functions 612 can perform fully 32-bit operations on the data 601 and 602. The selectors 501 and 503 (in FIG. 5) can be utilized to activate the desired path, and can control the processing and/or choose between 16-bit or 32-bit operations.

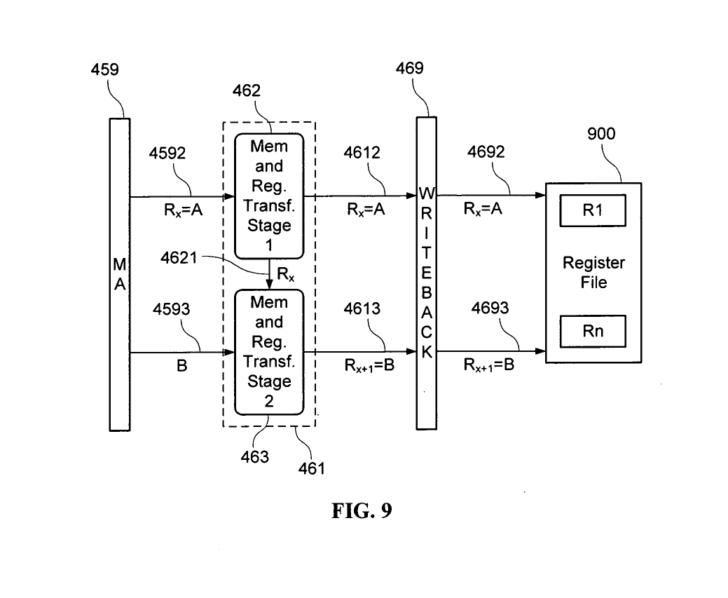

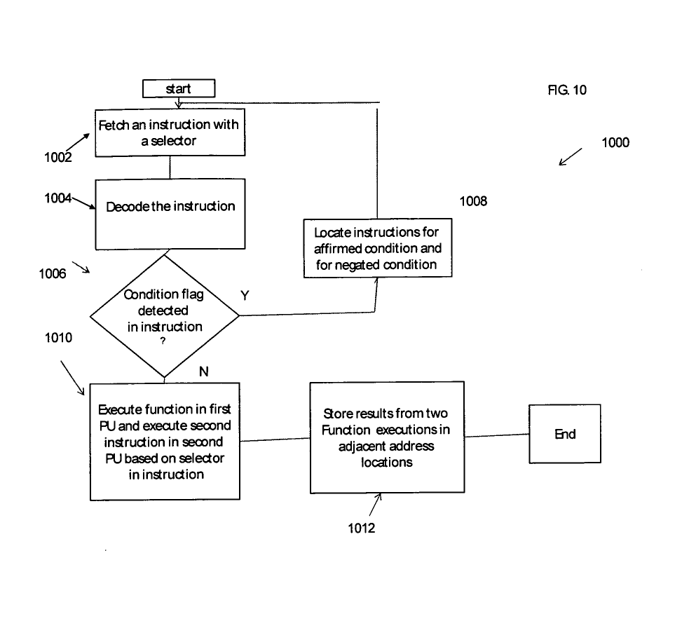

FIG. 9 depicts a block diagram of a communication flow from the split pipeline to the register file 900. The memory and register transfer stage 461 of the split pipeline in FIG. 9 can have two split stages 462 and 463. The split stage 462 in the first path can receive a signal 4592 which can contain a target register number Rₓ with a value A which can have been computed in a prior split execute stage 452 in the same path. The split stage 463 in the second path can receive a signal 4593 which can contain a value B which can have been computed in a prior split execute stage 453 in the same path. It is to note, that the signal 4593 does not contain a target register number as the target register number for the second path was not provided in the instruction code.

The split stage 463 can retrieve the destination register of the first path in signal 4621 from the split stage 462 and can determine a next register Rₓ₊₁ thereof. The split stage 462 can store the destination register number Rₓ along with the value A to be stored in this register in a buffer 469 using a signal 4612 and the split stage 463 can store the determined destination register number Rₓ₊₁ along with the value B to be stored in Rₓ₊₁ in buffer 469 using a signal 4613.

In a next cycle the register file 900 can retrieve two register load signals 4692 and 4693. Both signals can comprise a destination register number and a value to be stored in that destination register. The register file 900 can be dual ported to be able to handle two register load signals at each time. As described in FIG. 3, the register file can have registers enumerated from R1 to Rn.

As described above, the target register number for all paths except the first can be determined by a rule or predetermined function. In some embodiments the target register numbers of the next higher paths can be the register numbers following the target register number of the first path. As an example, for the instruction “R3,R4=AS(R1,R2)” (for which pipeline processing has been demonstrated in FIG. 7a to FIG. 7f) the following information can be contained in the instruction code 500: the target register number “R3” of the first path, the function code for the function “AS” to be executed and the register numbers “R1”, and “R2.” This information can be coded in the instruction code 500 in many different ways. However, it can be appreciated that no additional space in the code 500 is required to store the second destination register number “R4” as it can be implicitly determined from R3. Hence, it could be shown, that the instructions executed in all paths do only require one code definition for the first path thereby allowing the system to operate more efficiently.

Referring to FIG. 10 a flow diagram 1000 for a multipath processing system is disclosed. The method can include fetching an instruction from memory where the instruction contains a selector, as illustrated by block 1002. The instruction can be decoded as illustrated by block 1004. The instruction can be analyzed to determine if the instruction contains a condition, as illustrated in decision block 1006.

If the instruction contains a condition then as illustrated by block 1008 instructions can be locate that are needed whether the condition is true or affirmed or false and not affirmed as illustrated in block 1008. The process can iterate and these instructions can be fetched in accordance with block 1002. When no condition is connected or the condition was detected and the data for the resulting instruction(s) have been requested, then, as illustrated by block 1010 a first function can be executed by a first processing unit and a second function can be executed by a second processing unit. The functions can be selected for each processing unit based on the selector in the instruction that was originally fetched.

As illustrated by block 1012, the results from data that was processed with different functions and with different processing units can be stored in adjacent memory address locations. In some embodiments a single register value for a first path can be assigned a register number and the results for the second path can be stored in a register that is adjacent to the single register value. Such a default/predetermined storage allocation configuration can reduce the number and complexity of instruction that need to be processed by the system.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The processor can retrieve instructions from an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can efficient process data in a pipeline. It is understood that the form of the arrangements shown and described in the detailed description and the drawings are to be taken merely as examples. It is intended that the following claims be interpreted broadly to embrace all the variations of the example embodiments disclosed.

What is claimed is:

1. A system comprising:
a fetch stage to retrieve an instruction the instruction having more than one function selector;
a decode stage to decode the retrieved instruction;
a first processing unit to execute at least a part of the retrieved instruction in response to at least part of the more than one function selector; and
a second processing unit to execute at least a part of the retrieved instruction in response to at least part of the more than one function selector.

2. The system of claim 1, wherein the first processing unit and the second processing unit to execute the instruction in response to contents of the instruction.

3. The system of claim 1, further comprising a first function selection module to select a first function to be executed by the first processing unit.

4. The system of claim 1, further comprising a second function processing module to select a second function to be executed by the second processing unit wherein the same data is processed by the first and second processing unit and the second function is different than the first function.

5. The system of claim 1, wherein the first processing unit to utilize a sixteen bit bus.

6. The system of claim 1, further comprising a detector module to detect a condition in the retrieved instruction and to facilitate loading of instructions in response to and affirmed condition and not loading the instruction in response to negated condition.

7. The system of claim 1, further comprising a feedback path to return a result from one of the first processing unit or the second processing unit to an input of the at least one first or second processing unit.

8. The system of claim 1, wherein the first processing unit produces a first result and the second processing unit produces a second result and the first result and the second result are placed in memory locations with adjacent addresses in the register file absent a register assignment instruction.

9. The system of claim 1, further comprising a function select module that selects an output from one of the first processing unit or the second processing unit based on a selector portion of the retrieved instruction.

10. A method comprising:
loading an instruction into a multi-path pipeline, the instruction having at least two selector sub-instructions;
performing a first function on at least a portion of the instruction by a first processing unit in a first path in response to the selector sub-instructions; and
performing a second function on at least a portion of the instruction by a second processing unit in a second path in response to the selector sub-instructions.

11. The method of claim 10, further comprising detecting a condition in the instruction and loading instructions to support both an affirmative result from executing the condition and a negative result from executing the condition.

12. The method of claim 10, further comprising executing a first instruction with first data and executing a second instruction with the first data and storing results from the second instruction in memory location that has an address that is consecutive with a memory location utilized to store results from the first instruction.

13. The method of claim 10, further comprising activating a one processing path from a plurality of processing paths.

14. The method of claim 10, further comprising feeding back a control signal from a stage that is subsequent to the first processing unit and selecting a function with the control signal.

15. The method of claim 10, further comprising feeding back a control signal from a stage that is subsequent to the second processing unit and selecting a function with the control signal.

16. A machine-accessible medium containing instructions which, when the instructions are executed by a machine, cause said machine to perform operations, comprising:
loading an instruction into a multi-path pipeline, the instruction having at least two selector sub-instructions;
performing a first function on at least a portion of the instruction by a first processing unit in a first path in response to the selector sub-instructions; and
performing a second function on at least a portion of the instruction by a second processing unit in a second path in response to the selector sub-instructions.

17. The machine-accessible medium of claim 16, that when executed causes the computer to detect a condition in the instruction and loading instructions to support both an affirmative result from executing the condition a negative result from execution of the condition.

18. The machine-accessible medium of claim 16, that when executed causes the computer to execute a first instruction with first data and executing a second instruction with the first data and storing results from the second instruction in memory location that has an address that is consecutive with a memory location utilized to store results from the first instruction.

19. The machine-accessible medium of claim 16, that when executed causes the computer to activate one processing path from a plurality of processing paths.

20. The machine-accessible medium of claim 16, that when executed causes the computer to feed back a control signal from a stage that is subsequent to the first processing unit and selecting a function with the control signal.
